(19) United States
(12) Patent Application Publication
(10) Pub. No.: US 2002/0172620 A1
(43) Pub. Date: Nov. 21, 2002

(54) Systems and methods for rapid evaluation of chemical resistance of materials

(76) Inventor: Radislav Alexandrovich Potyrailo, Niskayuna, NY (US)

Correspondence Address: GENERAL ELECTRIC COMPANY, GLOBAL RESEARCH CENTER, PATENT DOCKET RM. 4A59, PO BOX 8, BLDG. K-1 ROSS, NISKAYUNA, NY, 12309, US

(21) Appl. No.: 09/681,431

(22) Filed: Apr. 4, 2001

(51) Int. Cl. G01N 27/00

(52) U.S. Cl. 422/82.02; 422/82.11; 422/88; 422/90; 422/98

(57) ABSTRACT

RD-2ems and methods are disclosed for evaluation of small amounts of materials of interest for their resistance to exposure to environmental parameters such as chemicals. The invention also enables analysis of multiple samples simultaneously. Embodiments of the invention include the use of acoustic-wave devices for evaluation of chemical resistance of materials to a chemical, where the materials are deposited on the acoustic-wave devices or are resident in a volume of the chemical used for the material evaluation.

### BACKGROUND OF INVENTION

This invention relates to systems and methods for rapid evaluation of chemical resistance of materials, the methods and devices being particularly useful with combinatorial screening of material properties.

Materials of increasing interest with respect to their chemical resistance include different types of polymers, polycarbonate, polycarbonate blends, silicones, polycarbonate-polyorganosiloxane copolymers, polyetherimide resins, and many others. Among the solvents of interest to test these materials are different fuels, alkaline and acidic solutions, water, organic solvents of different polarity, and solvent mixtures.

Conventional methods of measurement of chemical resistance require exposure of a sample material to a solvent for extended periods of time. For example, the tests can extend for up to seven or more days at room temperature, or about three days at an elevated temperature. Thus, conventional methods for evaluation of chemical resistance of materials are typically too time consuming and resource consuming to be applicable to the rapid screening of a large number of materials, such as those developed in combinatorial chemistry. Further, traditional measurement techniques are difficult to apply for measurements of multiple, small samples simultaneously. For example, the solvent resistance test known as the methylethyl ketone (MEK) dynamic rub test, ASTM Method D 1308 is difficult to perform on numerous, small material samples. In addition, accuracy of measurements are typically limited by the accuracy of balance scales to measure mass gain or loss, thereby requiring large samples in order to detect mass changes.

There remains an unmet need for methods and devices for evaluation of chemical, and particularly solvent, resistance of materials, in which the methods and devices allow greatly increased speed of measurement of samples. There is a further unmet need for methods and devices that permit analysis of multiple samples simultaneously and that enable rapid analysis of much smaller quantities of dissolved residual materials in solutions than existing methods.

### SUMMARY OF INVENTION

The present invention overcomes the problems of the prior art by providing systems and methods for the simultaneous evaluation of chemical resistance of small amounts of materials.

To solve the above-described problems, in one embodiment, a high throughput screening system for evaluating chemical resistance comprises: at least one chemical selected from a plurality of chemicals; a plurality of materials exposable to the chemical; a plurality of acoustic-wave devices each associated with a corresponding one of the plurality of materials and each having a first acoustic-wave property and a second acoustic-wave property, wherein for each of the plurality of acoustic-wave devices the first acoustic-wave property corresponds to an acoustic-wave property prior to exposure to the corresponding one of the plurality of materials to the chemical and the second acoustic-wave property corresponds to an acoustic-wave property subsequent to exposure to the corresponding one of the plurality of materials to the chemical; an acoustic-wave property detector for measuring the first acoustic-wave property and the second acoustic-wave property of each of the plurality of acoustic-wave devices; and an analyzer for determining an acoustic-wave property change between the first acoustic-wave property and the second acoustic-wave property for each of the plurality of materials, wherein for each of the plurality of materials the acoustic-wave property change is correlated to a chemical resistance to the chemical.

In another embodiment, a system for measuring a variation in each of a plurality of minute samples of materials of interest comprises: a plurality of acoustic-wave devices, wherein one from the plurality of samples is deposited on each of the plurality of acoustic-wave devices; at least one oscillation source coupled to each of the plurality of acoustic-wave devices, such that each of the plurality of acoustic-wave devices has an applied oscillation potential, the applied oscillation potential producing in each of the plurality of acoustic-wave devices an acoustic-wave property, wherein the acoustic-wave property for each of the plurality of acoustic-wave devices varies with a variation in the associated deposited sample; a plurality of acoustic-wave property detectors, each of the plurality of acoustic-wave property detectors associated with at least one from the plurality of acoustic-wave devices; and at least one processor coupled to the plurality of acoustic-wave property detectors, wherein the at least one processor is capable of calculating the variation in each of the plurality of applied samples as a function of the variation of the associated acoustic-wave property.

In yet another embodiment, a system for measuring a change in mass over time for a plurality of minute samples of materials of interest, wherein each of the plurality of samples has an associated mass, the system comprising: a plurality of acoustic-wave devices, wherein one from the plurality of samples is associated with a corresponding one of the plurality of acoustic-wave devices; a plurality of oscillation sources, at least one oscillation source coupled to each of the plurality of acoustic-wave devices such that each of the plurality of acoustic-wave devices has an applied oscillation potential, the applied oscillation potential producing in each of the plurality of acoustic-wave devices an oscillation frequency, wherein the oscillation frequency for each of the plurality of acoustic-wave devices varies with variation in the mass of the associated applied sample; at least one acoustic-wave property detector associated with each of the plurality of acoustic-wave devices, each acoustic wave property detector operable to measure the variation in oscillation frequency associated with each acoustic-wave device; and at least one processor coupled to the at least one acoustic-wave property detector, wherein the at least one processor is capable of calculating the change in mass of each of the plurality of applied samples as a function of the variation of the associated oscillation frequency.

In another embodiment, a high throughput method of evaluating chemical resistance, comprises: measuring a first acoustic-wave property of each one of a plurality of acoustic-wave devices associated with each of a plurality of materials, where the first acoustic-wave property corresponds to a property prior to exposure of each of the plurality of materials to a corresponding one of a plurality of chemicals; exposing each of the plurality of materials to the corresponding one of the plurality of chemicals; measuring a second acoustic-wave property of each one of the plurality of acoustic-wave devices associated with each of the plurality of materials, where the second acoustic-wave property corresponds to a property subsequent to exposure to the corresponding one of the plurality of chemicals; and analyzing an acoustic-wave property change between the first acoustic-wave property and the second acoustic-wave property for each of the plurality of acoustic-wave devices associated with each of the plurality of materials, where the acoustic-wave property change is correlated to a chemical resistance to the corresponding chemical for each of the plurality of materials.

In yet another embodiment, a method for measuring variation in a plurality of minute samples of materials of interest, the method comprises: applying an oscillating potential to each of a plurality of acoustic-wave devices prior to a variation in each of the plurality of samples such that each of the plurality of acoustic-wave devices has a first acoustic-wave device property; applying the oscillating potential to each of the plurality of acoustic-wave devices subsequent to the variation in at least one of the plurality of samples such that each of the plurality of acoustic-wave devices has a second acoustic-wave device property; determining a difference between the first acoustic-wave device property and the second acoustic-wave device property for each of the plurality of acoustic-wave devices; and calculating the variation in each of the plurality of applied samples based on the determined difference between the first acoustic-wave device property and the second acoustic-wave device property for each of the plurality of acoustic-wave devices.

In still another embodiment, a method for measuring mass over time for a plurality of minute samples of materials of interest, wherein each of the plurality of minute samples has an associated mass, the method comprises: applying an oscillating potential to each of a plurality of acoustic-wave devices prior to a mass variation in each of the plurality of samples such that each of the plurality of acoustic-wave devices has a first acoustic-wave device property; applying the oscillating potential to each of the plurality of acoustic-wave devices subsequent to a mass variation in at least one of the plurality of samples such that each of the plurality of acoustic-wave devices has a second acoustic-wave device property; determining a difference between the first acoustic-wave device property and the second acoustic-wave device property for each of the plurality of acoustic-wave devices; and calculating the variation of mass in each of the plurality of applied samples based on the determined difference between the first acoustic-wave device property and the second acoustic-wave device property for each of the plurality of acoustic-wave devices.

Additional features of the invention will be set forth in part in the description that follows, and in part will become more apparent to those skilled in the art upon examination of the following or upon learning by practice of the invention.

### BRIEF DESCRIPTION OF DRAWINGS

FIG. 1 presents a representative diagram of the various components of an embodiment of the present invention as applicable to a single sample and analysis;

FIG. 2 is a function diagram of the various components shown in FIG. 1 and described in conjunction therewith;

FIG. 3 depicts the results of a first example of a solvent resistance test with an acoustic-wave device for rapid detection of small quantities of dissolved materials, the example being in accordance with an embodiment of the present invention;

FIG. 4 presents the results of a second example of a solvent resistance test with an acoustic-wave device for rapid detection of small quantities of dissolved materials, the example being in accordance with one embodiment of the present invention;

FIG. 5 shows the results of an example of a typical solvent-dependent signal from an acoustic-wave device coated with a polycarbonate film used for direct monitoring of material/chemical interactions, the example being in accordance with an embodiment of the present invention;

FIG. 6 depicts the results of an example chemical resistance test with an acoustic-wave device coated with a film of an amorphous fluoropolymer as a reference material for evaluation of chemical stability, with signal being measured as a shift of output frequency from its baseline level in clear air, the example being in accordance with an embodiment of the present invention;

FIG. 7 presents the results of a chemical resistance test with an acoustic-wave device coated with a film of an amorphous fluoropolymer in accordance with an embodiment of the present invention;

FIGS. 8 and 9 are schematic representations of one embodiment of the simultaneous evaluation of chemical resistance of multiple material samples in accordance with an embodiment of the present invention, where residual amounts of the material of interest are dissolved in the chemical;

FIG. 10 is a flowchart of the method of determining the chemical resistance of each of the plurality of materials of interest of FIGS. 8 and 9;

FIG. 11 is a schematic representation of another embodiment of the simultaneous evaluation of chemical resistance of multiple material samples in accordance with an embodiment of the present invention, where residual amounts of the material of interest are removed from the acoustic-wave devices after exposure to a chemical; and

FIG. 12 is a flowchart of the method of determining the chemical resistance of each of the plurality of materials of interest of FIG. 11.

### DETAILED DESCRIPTION

Among other features, this invention discloses the use of acoustic-wave devices for evaluation of chemical resistance of materials. These measurements are performable on materials such as a coating on a device, a coating on a substrate in a well, a well that is coated with a material, a free standing coating, a bulk solid material, a powder, and a chopped material.

In the above cases, the measurement principle is based on the rapid determination of minute quantities of material removed from or deposited onto the surface of an acoustic-wave transducer. Such a device, also known as an acoustic-wave sensor, includes a piezoelectric crystal, which allows transduction between electrical and acoustic energies. These devices are known in a number of configurations. These configurations can be described based on their unique acoustic modes, such as thickness-shear mode (TSM), surface acoustic wave (SAW), acoustic plate mode (APM), flexural plate wave (FPW), and surface transverse wave (STW) devices. For further details, refer to Ballantine, D. S., Jr.; White, R. M.; Martin, S. J.; Ricco, A. J.; Frye, G. C.; Zellers, E. T.; Wohltjen, H. Acoustic Wave Sensors: Theory, Design, and Physico-Chemical Applications, Chps. 3 and 6, Academic Press: San Diego, Calif., 1997.

Non-piezoelectric acoustic wave devices can be also utilized. A thin-rod acoustic wave device is an example of a non-piezoelectric acoustic wave device. See, for example, Thompson, M.; Stone, D. C. Surface-Launched Acoustic Wave Sensors. Chemical Sensing and Thin-Film Characterization, Chapter 6, Wiley: New York, N.Y., 1997. The thin-rod acoustic wave device can be operated at low frequencies (˜200 kHz). Other acoustic wave devices can be also made of non-piezoelectric materials. These devices include cantilevers, torsion resonators, tuning forks, bimorphs (i.e. a type of two-pronged tuning fork), unimorphs (i.e. a type of single pronged tuning fork), membrane resonators, etc. Materials of construction can be glass, metals, etc.

The operating frequencies of these acoustic-wave devices may be in the following approximate ranges: thickness-shear mode (TSM), 0.170 MHz; surface acoustic wave (SAW), 30 10000 MHz; acoustic plate mode (APM), 20 500 MHz; flexural plate wave (FPW), 0.01 10 MHz; surface transverse wave (STW), 100 1000 MHz; and thin-rod acoustic wave (TRAW), 0.2 1 MHz. For the other non-piezoelectric acoustic-wave devices, such as the bimorphs, unimorphs, cantilevers, torsion resonators, tuning forks, membrane resonators, etc., the operating frequencies are in the range of about 1 Hz 1 MHz.

In general, the acoustic-wave device of embodiments of this invention operate in a frequency range of about 10 GHz 0.1 Hz, particularly in the range of about 500 MHz 1 kHz, and more particularly in the range of about 100 MHz 100 KHz. The active surface area of the acoustic-wave devices of embodiments of the invention are in the range of about 1×10⁻⁶ cm² to about 2 cm², particularly in the range of about 1×10⁻⁵ cm² to about 5×10⁻¹ cm², and more particularly in the range of about 1×10⁻⁴ cm² to about 5×10⁻² cm².

The acoustic wave devices are typically of about 0.2 mm to about 50 mm in size, in shapes such as diameter or rectangular, and 10 microns to 2 mm in thickness, although other shaped and sized devices may be utilized. Further, for example, the minute quantity of material may be in the range of about 1 picogram to about 1 milligram, more preferably about 100 picogram to about 10 milligram, and most preferably about 1 nanogram to about 1 microgram. The quantity of the material will depend upon the operating frequency of the device.

These devices can be one- or two-port devices. In one-port devices, such as TSM devices, a single port serves as both the input and the output port. The input signal excites an acoustic mode, which in turn generates charges on the input electrode. These signals combine to produce an impedance variation that constitutes the TSM resonator response. In two-port devices, one port is used as the input port and the other as an output port. The input signal generates an acoustic wave that propagates to a receiving transducer which generates a signal on the output port. The relative signal level and phase delay between input and output ports constitute two responses. See, for example, Ballantine, D. S., Jr.;

White, R. M.; Martin, S. J.; Ricco, A. J.; Frye, G. C.; Zellers, E. T.; Wohltjen, H. Acoustic Wave Sensors: Theory, Design, and Physico-Chemical Applications; Chps. 3 and 6, Academic Press: San Diego, Calif., 1997.

For example, in a TSM device, an oscillating potential is applied to electrodes deposited onto two opposite sides of a acoustic-wave material, such as a quartz crystal. This acoustic-wave material oscillates in the thickness-shear mode with a fundamental frequency measured using a conventional frequency counter. Such an acoustic-wave device allows measurement of such variations as the change in mass of a material or coating applied to the oscillating crystal, as well as several other properties of the material such as density and viscosity, after accounting for other factors, such as the dimensions and other parameters of the crystal, as well as variables, such as the temperature at which measurement is made.

When a material is deposited onto an acoustic wave device and is exposed to a solvent, the material is dissolvable (mass loss), is swellable (mass gain), or is mass unchanged, depending on the chemical resistance of the material to the solvent. Also, when a solvent used for material evaluation is deposited onto the crystal of the device, the mass of the crystal remains unchanged after solvent evaporation if there is no dissolved material in the solvent. In general, the thickness of the coating may be in the range of about 0.1 nanometers to about 100 micrometers, particularly in the range of about 1 nanometer to about 10 micrometers, and more particularly in the range of about 10 nanometers to about 1 micrometer.

The coating or material of interest may be applied to the device using thin-film deposition techniques in combination with physical masking techniques or photolithographic techniques. Such thin-film deposition techniques can generally be broken down into the following four categories: evaporative methods, glow discharge processes, gas-phase chemical processes, and liquid-phase chemical techniques. Included within these categories are, for example, sputtering techniques, spraying techniques, laser ablation techniques, electron beam or thermal evaporation techniques, ion implantation or doping techniques, chemical vapor deposition techniques, as well as other techniques used in the fabrication of integrated circuits. All of these techniques can be applied to deposit highly uniform layers, i.e., thin-films, of the various materials of interest on selected regions on the device. For an overview of the various thin-film deposition techniques that can be used in the methods of the present invention, see, for example, Ballantine, D.

S., Jr.; White, R. M.; Martin, S. J.; Ricco, A. J.; Frye, G. C.; Zellers, E. T.; Wohltjen, H. Acoustic Wave Sensors: Theory, Design, and Physico-Chemical Applications; Chapter 6, Academic Press: San Diego, Calif., 1997. Other types of coating procedures are also easily applicable in conjunction with the method of the present invention to deposit the materials of interest. These other coating procedures include, for example, spin-coating, brushing, and laser deposition.

The theory of operation of TSM devices is also applicable to other types of acoustic-wave devices such as bimorphs, unimorphs, cantilevers, torsion resonators, tuning forks, membrane resonators, etc. These other devices operate at low frequencies of several hundred hertz.

The mass change of the oscillating crystal of a TSM device is determined from the change in the resonant frequency of the crystal according to the Sauerbrey equation, as follows:

Δf=−2f₀²(m/A)(μ_{Q}ρ_{Q})^{-½} (1)

where Δ f is the change in resonant frequency upon material deposition or removal, f_{O} is the fundamental resonant frequency of the unloaded device, μ_{Q} is the shear modulus of the acoustic-wave substrate, ρ_{Q} is the substrate density, m is the total mass of the material deposited from solution to both faces of the crystal, and A is the active surface area of one face of the crystal.

In one example embodiment, acoustic-wave devices used in conjunction with the method and devices of this invention are 10-MHz AT-cut quartz crystals with an active electrode area of 0.2 cm². The mass sensitivity of a crystal per unit of frequency change is:

m/Δf=−A/(2f₀²)(μ_{Q}ρ_{Q})^{-½} (2)

The minus sign indicates that, upon increase in mass, the oscillation frequency decreases, while upon decrease in mass, the oscillation frequency increases. For the AT-cut quartz of this embodiment, μ_{Q}=2.947×10¹¹ g·cm⁻¹·s⁻² and ρ_{Q}=2.648 g·cm⁻³. Thus, the mass sensitivity of the device for this embodiment is as follows:

m/Δf=−0.883×10⁻⁹ g·Hz⁻¹ (3)

The above relationship demonstrates that the acoustic-wave device of this embodiment is able to detect the mass change of 0.883 nanograms when the resolution of the frequency measurement is 1 Hz, which is a typical noise level of frequency measurements. The mass sensitivity is easily improvable when an adequate gate time and temperature stabilization are utilized for frequency measurements. For example, in this case, the noise in the frequency measurement is reducible to 0.05 Hz, which provides a mass resolution of 44 picograms. The mass sensitivity of such measurements is thus approximately six orders of magnitude higher than conventional laboratory scale balances.

From equation (1) above, the change in resonant frequency Δf_{F} upon deposition of a film is relatable to the thickness of the film deposited onto the crystal, as follows:

Δf_{F}=−4f₀²ρ_{F}d_{F}(μ_{Q}ρ_{Q})^{-½} (4)

where ρ_{F} and d_{F} are, respectively, the density and thickness of the film. For the AT-cut quartz crystal oscillating at 10 MHz in accordance with the embodiment above, the film thickness (in cm) is given by the following equation:

d_{F}=2.2×10⁻⁹Δf_{F}/ρ_{F} (5)

Besides the change in mass of the oscillating crystal, other measurable parameters upon exposure to a solvent include the change in viscoelastic property of the deposited material, including density, viscosity, and crystallinity.

Other types of acoustic-wave devices are easily adaptable for the various applications described for this invention, as will be understood by those familiar with the art.

References will now be made in detail to embodiments of the present invention, examples of which are illustrated in the accompanying drawings.

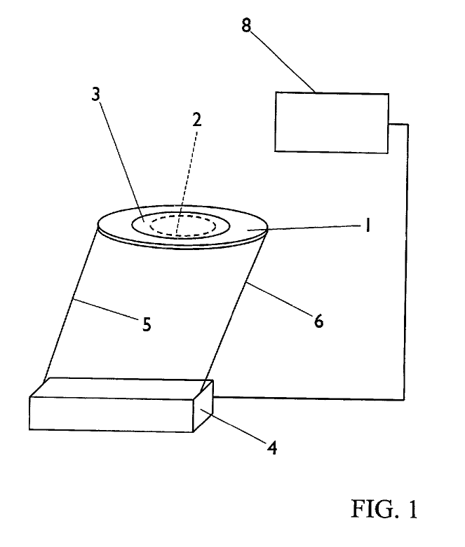

FIG. 1 presents a representative diagram of the various components of an embodiment of the present invention as shown in detail for a single sample. As shown in FIG. 1, for each sample, an embodiment of the present invention includes an acoustic-wave device 1, including a substrate such as a quartz, lithium niobate, nitride, lithium tantalate, bismuth germanium oxide, aluminum nitride, or gallium arsenide, and acoustic-wave films (ZnO and AIN). Non-piezoelectric materials are also used. Upon the acoustic-wave device 1 is deposited a material of interest 2, such as a coating with or without a solvent or other chemical 3 applied to the material of interest 2. Various components are used to produce an oscillation of the acoustic-wave device 1 with a predetermined oscillating potential applied, such as via an oscillating current source 4 powered by a power supply (e.g., a battery or other source of voltage, such as a 5 volt power supply either internal or external to the oscillating current source 4), and couplings 5, 6 between the oscillating current source 4 and the acoustic-wave device 1. Application of the oscillating current source 4 to the acoustic-wave device 1 creates an acoustic-wave device oscillation. Measurement of the acoustic-wave device property is made using a measurement device or devices 8, for display on a display device within the measurement device or coupled to the measurement device or devices. Such measurement device and display optionally includes, for example, a personal computer (PC), an oscilloscope, a microcomputer, a minicomputer, a mainframe computer, or other device having a processor. Other examples of measurement device 8 for measuring acoustic-wave properties include electronic equipment such as a network analyzer, a vector voltmeter, an impedance analyzer, frequency counter, a phase interferometer, and an in-phase and quadrature demodulator. Both the source 4 for applying the oscillating potential and the measurement device 8 may be associated with one or a plurality of devices, where a single oscillation source and/or a single measurement device may be utilized in combination with a multiplexer to sequentially initiate oscillation and/or determine the property, respectively, for each of a plurality of acoustic-wave devices.

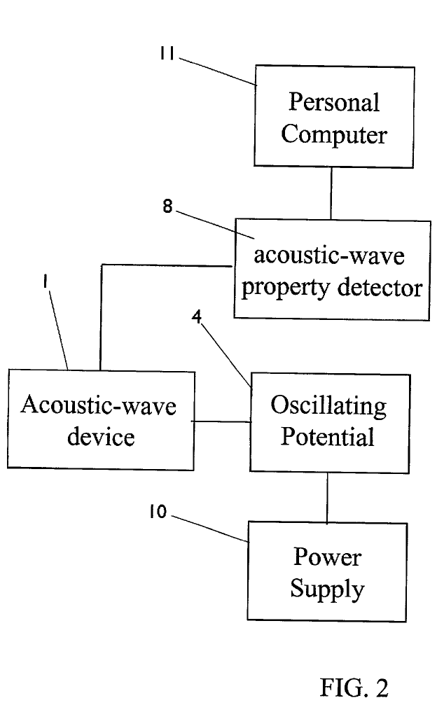

FIG. 2 is a function diagram of the various components shown in FIG. 1 and described in conjunction therewith. As shown in FIG. 2, the acoustic-wave device 1 is coupled to an oscillator 4, the oscillator 4 inducing a predetermined oscillation potential for oscillating the acoustic-wave device 1. The acoustic-wave device 1 having, for example, an applied material of interest, obtains a first property as a function of, among other factors, the mass of the acoustic-wave device 1 with applied material of interest and the frequency of the applied oscillation from the oscillator 4. The oscillator 4 is powered, for example, by an internal or external power supply 10, such as a battery.

With, for example, a chemical or solvent applied for a predetermined time period to the material of interest on the acoustic-wave device 1, the property changes from the initial or first property value to new or second property value. Suitable solvent exposure times may range from about 1 millisecond to about 1 year, preferably about 10 milliseconds to about 24 hours, more preferably from about 10 milliseconds to about 1 minute and most preferably from about 100 milliseconds to about 10 seconds. The second property may be measured at any time after exposure to a chemical. The second property varies, among other factors, as a function of the mass of the acoustic-wave device 1 with the material of interest and the applied chemical or solvent, for example. The oscillation potential may be continuously applied to the acoustic-wave device and the output frequency may be continuously measured. Note that two different oscillating potentials may be utilized in determining the first and second oscillation frequencies, however, a substantially similar oscillation potential is preferred in order to simplify the calculations.

The first measured acoustic wave property is taken at any time during the initial step in the test. The second acoustic wave property is taken at any time during the test. In this way, the change in material properties (mass, density, viscosity) may be recorded as a function of time. Therefore, at any time during the test it is possible to monitor material properties (mass, density, viscosity). These properties can be measured separately by monitoring a variety of parameters from the one- and two-port acoustic-wave device. These measured parameters include: fundamental oscillation frequency, harmonic oscillation frequency, impedance phase and magnitude of one-port devices, impedance phase and attenuation of two-port devices, wave velocity and wave attenuation, capacitance, and conductance.

Variations in the coating or material of interest, such as dissolution or swelling over time, that produce a difference between the first and second oscillation frequencies produced in the acoustic-wave device 1, are then determinable by comparing the first and second properties. For example, resultant variations in mass resulting from application of the chemical or solvent to the material of interest causes variation in the second property. The difference in property is then usable to determine the change in mass, for example. Such variations are determinable using, for example, a processor internal to or coupled to the measurement device 8. For example, a personal computer or PC 11 coupled to the measurement device 8 is usable to calculate mass/frequency changes due to application of the chemical or solvent to the material of interest by making calculations based on variations in the property data measured by the frequency counter 8.

Suitable examples of coatings or materials of interest to be tested for chemical resistance usable in conjunction with the present invention include, but are not limited to, any organic material, more preferably polymers with additives, and different types of polycarbonate, polycarbonate blends, silicones, polycarbonate-polyorganosiloxane copolymers, polyetherimide resins, and many others. Classes of polymers of interest include: polyolefins, vinyl and vinylidene polymers, natural and synthetic rubbers, polyesters, polycarbonates, cellulose derivatives, fluoropolymers, polyorganosiloxanes, polynitriles, polyamides, polyimides, polyurethanes, polyoxides, polysulfones, polyacetylenes, and polyacrylics.

Suitable chemicals or solvents usable in conjunction with the present invention include, but are not limited to, fuels; alkaline and acidic solutions; water; organic solvents of different polarity; solvent mixtures; gasoline; mixtures containing hexane; a hexane/toluene mixture; ketones such as methyl amyl ketone; glycol ethers such as 2-butoxy-ethoanol; glycol ether esters such as ethyl-3-ethoxy-propionate (EEP) and methoxy propyl acetate; toluene; methylethyl ketone (MEK); ester solvents such as ethyl acetate, butyl acetate, propyl acetate, and the like; alcohols such as butanol; 1-methdyl-2-pyrrolidinone; xylenes; and other volatile inert solvents.

In accordance with embodiments of the present invention, example uses of the methods and devices relating to the following will now be described: 1) rapid detection of small quantities, such as picogram quantities, of dissolved materials; 2) direct monitoring of coating material/chemical interactions; 3) reference materials for evaluation of chemical stability; and 4) devices for simultaneous evaluation of chemical resistance of materials in combinatorial screening applications. These examples are merely representative applications of the present invention, and thereby are not intended to be limiting of the invention to these particular illustrations.

The measurements of residual amounts of material in a chemical or solvent after chemical stability tests has the advantages of eliminating the time-consuming steps of drying tested material after being exposed to solvents and of providing the capability for direct comparison of solubility properties of different materials.

Experiments for the rapid determination of minute quantities of dissolved material for one example were performed by immersing a 0.0122-g pellet of polycarbonate (obtained from Scientific Polymer Products, Inc., of Ontario, N.Y.) in 500 microliters (μL) of chloroform for 10 s. The solvent was immediately applied as several 2-microliter droplets onto one of the sides of a 10 MHz crystal of a TSM device. The solvent then evaporated in 40 s, as indicated by the stabilization of the output frequency. Upon solvent evaporation, the frequency change associated with the deposited polycarbonate film was 193 Hz, and the standard deviation of the signal was 1.08 Hz. Thus, the 10 s immersion of a polycarbonate pellet into chloroform resulted in the device response with the signal-to-noise ratio of 178. The 193 Hz frequency change is the result of deposition of 170 nanograms (ng) of polycarbonate onto the surface of the acoustic-wave device. Chloroform was applied to remove the polycarbonate film. The film was removed in 100 s, as indicated by the stabilization of the output frequency.

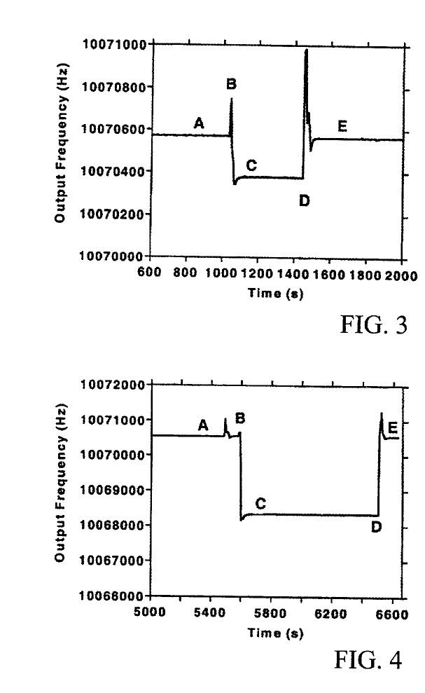

Results of this experiment are shown in FIG. For the experimental results in FIG. 3, monitoring regions of output frequency during the test included the following, as indicated on the figure: A) clean crystal; B)of chloroform solution onto the crystal surface after 10 s immersion of a polycarbonate pellet; C) 193 Hz frequency change as a result of 170 ng of polycarbonate deposited onto the crystal; D) removal of the deposited material with a solvent; and E) clean crystal.

In another example in accordance with an embodiment of the present invention, a 0.0154 g pellet of polycarbonate was immersed in 500 μL of chloroform for a much longer period of time, 60 s. The solvent was applied as several droplets onto both sides of a 10 MHz crystal. The solvent then evaporated in 60 s, as indicated by the stabilization of the output frequency. Upon solvent evaporation, the frequency change associated with the deposited polycarbonate film was 2.223 kHz, and the standard deviation of the signal was 0.98 Hz. Thus, the 60 s immersion of a polycarbonate pellet into chloroform resulted in the device response with the signal-to-noise ratio of 2268. The 2.223-kHz frequency change is the result of deposition of 1.963 micrograms (μg) of polycarbonate onto the surface of the acoustic-wave device. Chloroform was then applied to remove the polycarbonate film, and the film was removed in 100 s, as indicated by the stabilization of the output frequency.

Results of this experiment are presented in FIG. 4. Monitoring regions of output frequency during the test shown in FIG. 4 include the following: A) clean crystal; B) deposition of chloroform solution onto both crystal surfaces after 60 s immersion of a polycarbonate pellet; C) 2.223 kHz frequency change as a result of 1.963 μg of polycarbonate deposited onto the crystal; D) removal of the deposited material with a solvent; and E) clean crystal.

In this example, chemical properties of materials were evaluated in real time by applying materials onto the crystals of acoustic-wave devices and monitoring the output frequency upon exposure to different solvents. As an example, polycarbonate (obtained from Scientific Polymer Products, Inc., of Ontario, N.Y.) was dissolved in chloroform, and a 3.4 μm thick film was deposited from polymer solution onto the surface of the crystal by dip-coating. The film thickness was calculated using equation (5) above, based on the frequency change upon film deposition of 184 kHz and material density of 1.20.

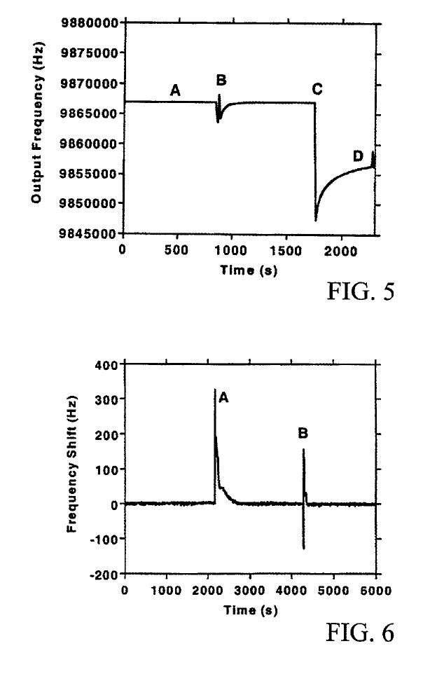

FIG. 5 demonstrates a typical solvent-dependent signal from the coated acoustic-wave device for this example. Monitoring regions of output frequency during the test shown in FIG. 5 include the following: A) crystal in air; B) reversible polycarbonate film interaction with methanol; C) exposure of the film to acetone; and D) signal from the polycarbonate film after exposure to acetone. The output frequency of the device is stable in air, as shown in region A. Upon exposure to methanol, in region B, the film does not lose its integrity and is stable after methanol evaporation. Upon exposure to acetone, reflected in region C, the polycarbonate film becomes crystalline, as demonstrated by the rapid decrease in oscillation frequency. Thus, as shown by this example, measurements using acoustic-wave devices, in accordance with the present invention, also permit the evaluation of amorphous/crystalline transitions. This approach also permits evaluation of chemical resistance of residual materials deposited onto the crystal in chemical resistance tests as described in previous example. .

In this example, films of amorphous fluoropolymer materials were used as reference materials to validate the previous experimental results. These films are extremely stable upon direct contact with a variety of common aggressive solvents, such as gasoline simulators (hexane/toluene mixture, 9:1 ratio) and those for dissolving of conventional polymers (chloroform) and highly alkaline solvents (ammonium hydroxide, sodium hydroxide), which decompose RTV silicone films, for example. These highly stable materials are random copolymers of tetrafluoroethylene (TEF) and perfluoro-2,2-dimethyl-1,3-dioxole (PDD), which is sold as Teflon® AF by DuPont® of Wilmington, Delaware. For film deposition, an amorphous fluoropolymer Teflon® AF 1600 was dissolved in perfluoro(2-butyl tetrahydrofuran), and a 1.3 μm thick film was deposited from polymer solution onto the surface of the crystal by dip-coating. The film thickness was calculated using equation (5) above, based on the frequency change upon film deposition of 104.5 kHz and material density of 1.8.

A typical response of a acoustic-wave device coated with a 1.3-μm thick film of Teflon® AF 1600 upon exposure to different solvents (methanol and chloroform) is presented in FIG. 6. Monitoring regions of output frequency during the test shown in FIG. 6 include the following: A) crystal exposed to methanol solvent; and B) crystal exposed to chloroform solvent. An excellent stability of an amorphous fluoropolymer film is evidenced by the constant output frequency of the acoustic-wave crystal before and after its exposure to the solvents.

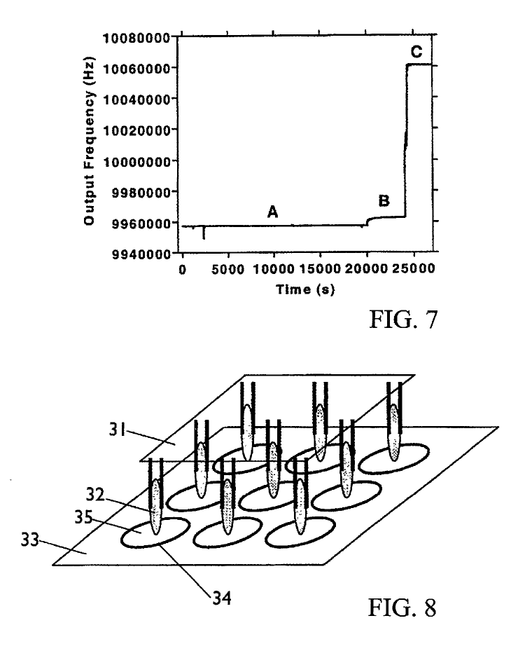

FIG. 7 demonstrates the stability of the amorphous fluoropolymer material toward the exposure to a hexane/toluene mixture (9:1 ratio), chloroform, ammonium hydroxide, methanol, acetone, and perfluoro(2-butyl tetrahydrofuran). The latter solvent is the only solvent that affects the film by dissolving it. Monitoring regions of output frequency during the test shown in FIG. 7 include the following: A) crystal exposed to different solvents (hexane/toluene (9:1 ratio)), chloroform, ammonium hydroxide, methanol, and acetone at different times; B) crystal exposed to several drops of perfluoro(2-butyl tetrahydrofuran); and C) the film is completely removed from the crystal by applying perfluoro(2-butyl tetrahydrofuran).

Table 1 shows the chemical resistance of amorphous fluoropolymer films, as determined using the test for reference materials for evaluation of chemical stability in accordance with this example. For the results shown in Table 1, the chemical resistance of these films was measured as the percent signal change of an acoustic-wave device coated with a 1.3 μm thick Teflon® AF 1600 film upon exposure to solvents.

TABLE 1
Chemical resistance of amorphous fluoropolymer films.*

| Solvent | Percent signal change |
|---|---|
| Hexane/toluene mixture, 9:1 ratio | −0.01 reversible |
| Chloroform | −0.09 reversible |
| Ammonium hydroxide | −0.03 reversible |
| Methanol | +0.3 reversible |
| Acetone | +0.1 reversible |
| Perfluoro(2-butyl tetrahydrofuran) | +100 non-reversible |

*measured as the percent signal change of a acoustic-wave crystal coated with a 1.3-picometer thick Teflon AF 1600 film upon exposure to solvents.

Simultaneous evaluation of multiple materials for their chemical resistance is performable using various approaches, such as those outlined as follows. These examples utilize arrays of coated and uncoated transducers, arrays of coating materials, and arrays of wells containing solvents.

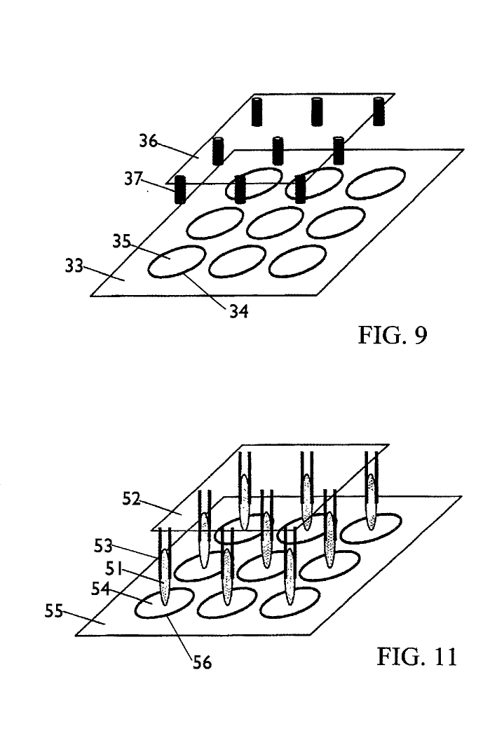

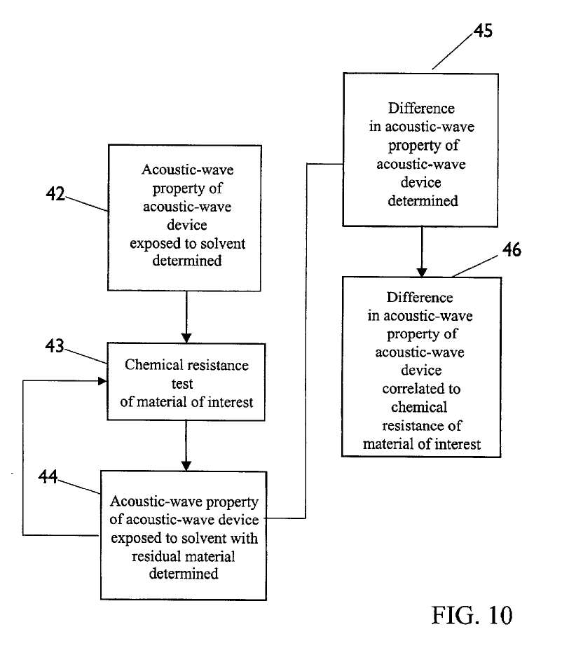

Referring to FIGS. 8-12, there are a number of systems and methods for carrying out the simultaneous evaluation of chemical resistance of multiple material samples in accordance with the present invention. Referring to FIGS. 8-10, in one embodiment of a system and method for measuring an amount of a material of interest dissolved in a solvent for a plurality of combinations of materials and solvents, an array 31 of devices 32 is immersed in a corresponding array 33 of wells 34 each containing one of a plurality of solvents 35. An oscillating potential is applied to each device of the array 31 of devices 32 and a first oscillation parameter of each of the plurality of solvents 35 is determined (Block 42). Then, the array 31 of devices 32 is removed and an array 36 of material samples 37 is immersed into the corresponding array 33 of wells 34 and exposed to the chemical solvent 35 for a predetermined exposure time (Block 43). The material samples 32 are selected from a plurality of materials of interest, and the material samples in the array may be identical or they may be different. The solvents 35 in the wells 34 may similarly be all the same or different. In general, in order to facilitate combinatorial discovery of desired materials of interest, there is some difference between each combination of material sample/solvent including some replicates. Once the predetermined exposure time has been reached, the material samples 32 are removed from the wells 34. Depending on the chemical resistance of each of the material samples 32, a residual amount of dissolved material of the material sample may remain within each well. For example, the mass of the residual amount of material left in a well may be in the range of about 1×10⁻¹² gram to about 1 gram, particularly in the range of about 1×10⁻⁹ gram to about 1×10⁻¹ gram, and more particularly in the range of about 1×10⁻⁶ gram to about 1×10⁻³ gram. The devices 32 are reinserted into the wells 34 and the oscillating potential is applied to determine a second oscillation frequency for each of the plurality of solvents 35 (Block 44). The difference in oscillation parameter between the first and second parameters is then determined, via computer or manually (Block 45). For example, if a given material sample 37 has a high solvent resistance, then the respective solvent may not contain any residual material and there would be a frequency change of zero. Alternatively, if a given material sample 37 has a lower solvent resistance, then the respective solvent may contain an amount of residual material and there would be a resultant change of the oscillation parameter. Any difference in oscillation parameter that is determined is then correlated to a chemical resistance of the material (Block 46).

Alternately, instead of immersing the devices in the wells of solvent before and after exposure to the materials of interest, a predetermined amount of each solvent can be deposited onto the device before and after exposure to the material of interest and the device oscillation is then determined. For example, the predetermined amount of each solvent includes a volume in the range of about 1×10⁻¹⁵ liter to about 1×10⁻³ liter, particularly in the range of about 1×10⁻¹² liter to about 1×10⁻⁴ liter, and more particularly in the range of about 1×10⁻⁹ liter to about 1×10⁻⁵ liter. In this manner, the predetermined amount of solvent after exposure may contain a residual amount of dissolved material and thereby cause a change in oscillation frequency that is correlated to chemical resistance. For example, the mass of the measured residual material may be in the range of about 1×10⁻¹⁵ gram to about 1×10⁻³ gram, particularly in the range of about 1×10⁻¹³ gram to about 1×10⁻⁴ gram, and more particularly in the range of about 1×10⁻¹² gram to about 1×10⁻⁵ gram.

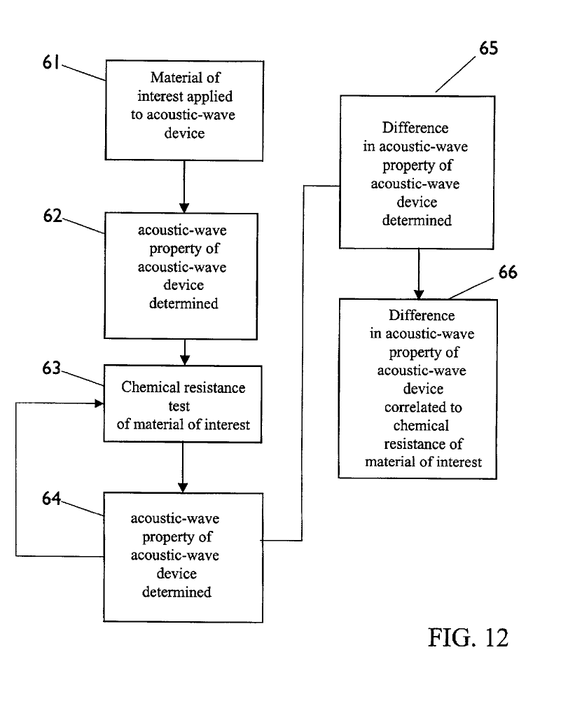

Referring to FIGS. 11 and 12, an embodiment of a system and method of the present invention includes measuring an amount of a deposited material of interest removed from an acoustic-wave device for a plurality of combinations of materials and solvents. One of a plurality of materials of interest 51, such as a material having resistance to a chemical such as a solvent, is deposited onto each one of an array 52 of acoustic-wave devices 53 (Block 61). For example, the mass of the deposited film is in the range of about 1×10⁻²¹ gram to about 1×10⁻³ gram, particularly in the range of about 1×10⁻¹⁵ gram to about 1×10⁻⁴ gram, and more particularly in the range of about 1×10⁻¹² gram to about 1×10⁻⁵ gram. An oscillating potential is then applied to the acoustic-wave devices with the material of interest deposited thereon, and a first oscillation parameter is determined or monitored (Block 62). The material of interest 51 on each device 53 is then exposed to one of a plurality of chemicals 54 for which resistance is to be determined, each contained in an array 55 of wells 56 (Block 63). After exposing the materials of interest 51 to the solvents 54 for a predetermined period of time, a residual amount of the material of interest may be removed from the device and deposited into the solvent, depending on the chemical resistance of the given material of interest to the given solvent. The devices 53 are removed from the wells 56, and the oscillating potential is again applied to each acoustic-wave device and a second oscillation frequency for the acoustic-wave device subsequent to exposure of the material of interest to the chemical is determined or monitored (Block The change in value of the oscillation frequency between the first oscillation frequency and the second oscillation frequency is determined (Block 65), and the frequency change is then correlated to the resistance of the material of interest to the chemical (Block 66). For example, a change in frequency resulting from a decrease in mass or viscoelastic property of the material of interest is correlatable to dissolution of the material of interest by the chemical.

Conventional liquid-handling instruments (for example, Quadra 96 Model 230 liquid delivery system available from Tomtec, Orange, Connecticut, and an eight-probe liquid handler system from Gilson, Model Lissy from Zinsser Analytic of Frankfurt, Germany) are usable to deposit solutions to and from the wells, and onto the individual crystals of an array of acoustic-wave devices.

In another embodiment, when the crystal array and solvent well array have different layouts, a conventional liquid-handling instrument with variable spacing between the liquid-deliver tips (for example, Model Lissy from Zinsser Analytic of Frankfurt, Germany) is adopted, for example, to transfer solvents from the wells directly onto the array of crystals or into another array of wells.

In another embodiment, the crystals are incorporated into the array of solvent-containing wells to eliminate the separate step of coating the crystals and to simplify handling of volatile solvents. Furthermore, immersing the material samples and coating the crystals may be conducted in a single step when each material is arranged with its corresponding acoustic-wave crystal in an array.

In yet another embodiment, delivery of solid samples of materials to the solvent-containing wells is accomplished using, for example, a conventional solid-handling instrument (for example, Zinsser Analytic, Model Lissy). Such an instrument is capable of delivering a predetermined amount of a solid material into each of the wells, previously filled with a solvent or filled with a solvent after the delivery of a solid sample. Stirring, if needed, is provided using, for example, known stirring equipment for multiple wells (e.g., a heating/stirring module Reacti-Therm III available from Pierce of Rockford, Ill.). Many other alternative methods for transferring a portion or all of the solvents or other chemicals in the wells to the acoustic-wave devices are well known in the art.

Thus, the methods and devices of the present invention provide for high throughput analysis of the chemical resistance of various combinations of arrays of materials of interest and arrays of solvents by determining a change in frequency resulting from a minute amount of material of interest being removed from a device or dissolving in a solvent. Therefore, based on the fast determination of chemical resistance for a plurality of materials of interest, new and improved formulations for materials having desirable chemical resistance may be discovered.

Example embodiments of the present invention have now been described in accordance with the above advantages. It will be appreciated that these examples are merely illustrative of the invention. Many variations and modifications will be apparent to those skilled in the art.

1. A high throughput screening system for evaluating chemical resistance, comprising:
at least one chemical selected from a plurality of chemicals;
a plurality of materials exposable to the chemical;
a plurality of acoustic-wave devices each associated with a corresponding one of the plurality of materials and each having a first acoustic-wave property and a second acoustic-wave property, wherein for each of the plurality of acoustic-wave devices the first acoustic-wave property corresponds to an acoustic-wave property prior to exposure to the corresponding one of the plurality of materials to the chemical and the second acoustic-wave property corresponds to an acoustic-wave property subsequent to exposure to the corresponding one of the plurality of materials to the chemical;
an acoustic-wave property detector for measuring the first acoustic-wave property and the second acoustic-wave property of each of the plurality of acoustic-wave devices; and
an analyzer for determining an acoustic-wave property change between the first acoustic-wave property and the second acoustic-wave property for each of the plurality of materials, wherein for each of the plurality of materials the acoustic-wave property change is correlated to a chemical resistance to the chemical.

2. The system of claim 1, wherein the second acoustic-wave property correlates to a mass of dissolved material.

3. The system of claim 2, wherein the mass of dissolved material is in the range of about 1×10⁻¹⁵ gram to about 1×10⁻³ gram.

4. The system of claim 1, where the acoustic-wave device is a one-port device.

5. The system of claim 1, where the acoustic wave device is a two-port device.

6. The system of claim 1, where the acoustic-wave device is a piezoelectric device.

7. The system of claim 6, where the piezoelectric acoustic-wave device is selected from the group consisting of a thickness-shear mode (TSM) device, a surface acoustic wave (SAW) device, an acoustic plate mode (APM) device, a flexural plate wave (FPW) device, and a surface transverse wave (STW) device.

8. The system of claim 1, where the acoustic wave device is a non-piezoelectric acoustic-wave device.

9. The system of claim 8, where the non-piezoelectric acoustic-wave device is selected from the group consisting of a thin-rod acoustic-wave (TRAW) device, a bimorph device, a unimorph device, a cantilever, a torsion resonator, a tuning fork, and a membrane resonator.

10. The system of claim 1, where the acoustic-wave property is selected from the group consisting of fundamental oscillation frequency, harmonic oscillation frequency, impedance phase and magnitude, impedance phase and attenuation, wave velocity and wave attenuation, capacitance, and conductance.

11. The system of claim 1, where the acoustic-wave property detector is selected from the group consisting of a frequency counter, a network analyzer, a vector voltmeter, an impedance analyzer, a phase interferometer, and an in-phase and quadrature demodulator.

12. The system of claim 1, wherein each of the plurality of materials has a mass, and wherein the mass is in the range of 1×10⁻¹² gram to about 1 gram.

13. The system of claim 1, wherein the acoustic-wave property change comprises a difference between the first acoustic-wave property and the second acoustic-wave property, wherein the difference in acoustic-wave property corresponds to a time of exposure of the chemical to each corresponding one of the plurality of materials.

14. The system of claim 13, wherein the time of exposure is in the range of about 1 millisecond to about 1 year.

15. The system of claim 13, wherein the time of exposure is in the range of about 10 milliseconds to about 24 hours.

16. The system of claim 13, wherein the time of exposure is in the range of about 100 milliseconds to about 1 hour.

17. The system of claim 1, wherein the plurality of materials are selected from a group consisting of organic materials, polymers, polymers with additives, polyolefins, polycarbonate, polycarbonate blends, silicones, polycarbonate-polyorganosiloxane copolymers, polyetherimide resins, a copolymer of tetrafluoroethylene and perfluoro-2,2-dimethyl-1,3-dioxole, and an amorphous fluoropolymer material.

18. The system of claim 1, wherein the plurality of materials are selected from a group consisting of polyolefins, vinyl and vinylidene polymers, natural and synthetic rubbers, polyesters, polycarbonates, cellulose derivatives, fluoropolymers, polyorganosiloxanes, polynitriles, polyamides, polyimides, polyurethanes, polyoxides, polysulfones, polyacetylenes, polyacrylics.

19. The system of claim 1, wherein the at least one chemical comprises one selected from a group consisting of an organic solvent, water, fuel, an alkaline solution, an acidic solution, gasoline, a hexane/toluene mixture, a ketone, a glycol ether, a glycol ether ester, a toluene, a methylethyl ketone, an ester solvent, an alcohol, 1-methdyl-2-pyrrolidinone, a xylene, a volatile inert solvent, chloroform, ammonium hydroxide, sodium hydroxide, methanol, acetone, a fluorinated solvent, and perfluoro(2-butyl tetrahydrofuran).

20. The system of claim 1, wherein the acoustic-wave property detector is capable of sequential measurement of the second acoustic-wave property for each of the plurality of acoustic-wave devices.

21. The system of claim 1, wherein the second acoustic-wave property differs from the first acoustic-wave property as a function of a mass of an undissolved portion of the corresponding one of the plurality of materials.

22. The system of claim 1, wherein the second acoustic-wave property differs from the first acoustic-wave property as a function of a mass of a dissolved portion of the corresponding one of the plurality of materials.

23. The system of claim 1, wherein the second acoustic-wave property differs from the first acoustic-wave property as a function of a mass of an undissolved portion of a corresponding one of the plurality of materials and as a function of a mass of absorbed portions of the chemical.

24. A system for measuring a variation in each of a plurality of minute samples of materials of interest, the system comprising:
a plurality of acoustic-wave devices, wherein one from the plurality of samples is deposited on each of the plurality of acoustic-wave devices;
at least one oscillation source coupled to each of the plurality of acoustic-wave devices, such that each of the plurality of acoustic-wave devices has an applied oscillation potential, the applied oscillation potential producing in each of the plurality of acoustic-wave devices an acoustic-wave property, wherein the acoustic-wave property for each of the plurality of acoustic-wave devices varies with a variation in the associated deposited sample;
a plurality of acoustic-wave property detectors, each of the plurality of acoustic-wave property detectors associated with at least one from the plurality of acoustic-wave devices; and
at least one processor coupled to the plurality of acoustic-wave property detectors, wherein the at least one processor is capable of calculating the variation in each of the plurality of applied samples as a function of the variation of the associated acoustic-wave property.

25. The system of claim 24, wherein each of the plurality of samples comprise a material selected from a group consisting of polyolefins, vinyl and vinylidene polymers, natural and synthetic rubbers, polyesters, polycarbonates, cellulose derivatives, fluoropolymers, polyorganosiloxanes, polynitriles, polyamides, polyimides, polyurethanes, polyoxides, polysulfones, polyacetylenes, and polyacrylics.

26. The system of claim 24, wherein each of the plurality of samples comprise a material selected from a group consisting of polyolefins, vinyl and vinylidene polymers, polyesters, polycarbonates, cellulose derivatives, polyorganosiloxanes, polynitriles, polyamides, polyimides, polyurethanes, polyoxides, polysulfones, polyacetylenes, and polyacrylics.

27. The system of claim 24, wherein at least one from the plurality of samples comprises a deposited film.

28. The system of claim 24, wherein the plurality of acoustic-wave devices comprise a device selected from the group consisting of a thickness-shear mode (TSM) device, a surface acoustic wave (SAW) device, an acoustic plate mode (APM) device, a flexural plate wave (FPW) device, a surface transverse wave (STW) device, thin-rod acoustic wave (TRAW), a bimorph, a unimorph, a cantilever, a torsion resonator, a tuning fork, and a membrane resonator.

29. The system of claim 24, wherein the plurality of acoustic-wave devices operate in a frequency range of about 10 GHz to about 0.1 Hz.

30. The system of claim 24, wherein the plurality of acoustic-wave devices operate in a frequency range of about 500 MHz to about 1 kHz.

31. The system of claim 24, wherein the plurality of acoustic-wave devices operate in a frequency range of about 100 MHz to about 100 KHz.

32. The system of claim 24, wherein the oscillation source comprises an oscillating potential.

33. The system of claim 24, wherein the variation in the associated applied sample comprises a change in mass.

34. The system of claim 33, wherein the change in mass occurs via absorption of a chemical.

35. The system of claim 34, wherein the chemical comprises a solvent.

36. The system of claim 35, wherein the solvent comprises one selected from a group consisting of a hydrocarbon fuel, an alkaline solution, an acidic solution, water, an organic solvent, gasoline, a hexane/toluene mixture, chloroform, ammonium hydroxide, sodium hydroxide, methanol, acetone, and a fluorinated solvent.

37. The system of claim 33, wherein the change in mass occurs via dissolution by a chemical.

38. The system of claim 24, wherein the measuring of the variation occurs over an exposure time, the exposure time comprising a time in the range of about 10 milliseconds to 24 hours.

39. The system of claim 24, wherein the processor comprises one selected from a group consisting of a personal computer, a minicomputer, a microcomputer, an oscilloscope and a mainframe computer.

40. A system for measuring a change in mass over time for a plurality of minute samples of materials of interest, wherein each of the plurality of samples has an associated mass, the system comprising:
a plurality of acoustic-wave devices, wherein one from the plurality of samples is associated with a corresponding one of the plurality of acoustic-wave devices;
a plurality of oscillation sources, at least one oscillation source coupled to each of the plurality of acoustic-wave devices such that each of the plurality of acoustic-wave devices has an applied oscillation potential, the applied oscillation potential producing in each of the plurality of acoustic-wave devices an oscillation frequency,
wherein the oscillation frequency for each of the plurality of acoustic-wave devices varies with variation in the mass of the associated applied sample;
at least one acoustic-wave property detector associated with each of the plurality of acoustic-wave devices, each acoustic wave property detector operable to measure the variation in oscillation frequency associated with each acoustic-wave device; and
at least one processor coupled to the at least one acoustic-wave property detector, wherein the at least one processor is capable of calculating the change in mass of each of the plurality of applied samples as a function of the variation of the associated oscillation frequency.

41. The system of claim 40, wherein the change in mass calculable by the system is in the range of about 1 picogram to about 1 milligram.

42. The system of claim 40, wherein the change in mass calculable by the system is in the range of about 1 nanogram to about 1 microgram.

43. The system of claim 40, wherein the at least one processor is operable to correlate the change in mass to a chemical resistance measurement.

44. A high throughput method of evaluating chemical resistance, comprising:
measuring a first acoustic-wave property of each one of a plurality of acoustic-wave devices associated with each of a plurality of materials, where the first acoustic-wave property corresponds to a property prior to exposure of each of the plurality of materials to a corresponding one of a plurality of chemicals;
exposing each of the plurality of materials to the corresponding one of the plurality of chemicals;
measuring a second acoustic-wave property of each one of the plurality of acoustic-wave devices associated with each of the plurality of materials, where the second acoustic-wave property corresponds to a property subsequent to exposure to the corresponding one of the plurality of chemicals; and
analyzing an acoustic-wave property change between the first acoustic-wave property and the second acoustic-wave property for each of the plurality of acoustic-wave devices associated with each of the plurality of materials, where the acoustic-wave property change is correlated to a chemical resistance to the corresponding chemical for each of the plurality of materials.

45. A method for measuring variation in a plurality of minute samples of materials of interest, the method comprising:
applying an oscillating potential to each of a plurality of acoustic-wave devices prior to a variation in each of the plurality of samples such that each of the plurality of acoustic-wave devices has a first acoustic-wave device oscillation frequency;
applying the oscillating potential to each of the plurality of acoustic-wave devices subsequent to the variation in at least one of the plurality of samples such that each of the plurality of acoustic-wave devices has a second acoustic-wave device oscillation frequency;
determining a difference between the first acoustic-wave device oscillation frequency and the second acoustic-wave device oscillation frequency for each of the plurality of acoustic-wave devices; and
calculating the variation in each of the plurality of applied samples based on the determined difference between the first acoustic-wave device oscillation frequency and the second acoustic-wave device oscillation frequency for each of the plurality of acoustic-wave devices.

46. The method of claim 45, where the variation is correlated to a chemical resistance.

47. A method for measuring mass over time for a plurality of minute samples of materials of interest, wherein each of the plurality of minute samples has an associated mass, the method comprising:
applying an oscillating potential to each of a plurality of acoustic-wave devices prior to a mass variation in each of the plurality of samples such that each of the plurality of acoustic-wave devices has a first acoustic-wave device oscillation frequency;
applying the oscillating potential to each of the plurality of acoustic-wave devices subsequent to a mass variation in at least one of the plurality of samples such that each of the plurality of acoustic-wave devices has a second acoustic-wave device oscillation frequency;
determining a difference between the first acoustic-wave device oscillation frequency and the second acoustic-wave device oscillation frequency for each of the plurality of acoustic-wave devices; and
calculating the variation of mass in each of the plurality of applied samples based on the determined difference between the first acoustic-wave device oscillation frequency and the second acoustic-wave device oscillation frequency for each of the plurality of acoustic-wave devices.

48. The method of claim 47, where the variation of mass is correlated to a chemical resistance.

49. The method of claim 47, further comprising continuously applying the oscillating potential and continuously measuring the second acoustic-wave device oscillation frequency.
